(19) United States
(12) Patent Application Publication
(10) Pub. No.: US 2008/0071640 A1
(43) Pub. Date: Mar. 20, 2008

(54) Portal for commercial transactions

(76) Inventor: Martin Khang Nguyen, Westminster, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/985,484

(22) Filed: Nov. 14, 2007

Related U.S. Application Data
(63) Continuation-in-part of application No. 09/931,677, filed on Aug. 15, 2001, now abandoned.
(63) Continuation-in-part of application No. 10/461,556, filed on Jun. 12, 2003, now abandoned.

(51) Int. Cl. G06Q 30/00

(52) U.S. Cl. 705/26

(57) ABSTRACT

An embodiment of the present invention is a portal for commercial transactions. A user interface interfaces to a user performing a commercial transaction. The user is one of a consumer, a vendor, a retailer, a service provider, and a third-party entity. The commercial transaction is related to sale processing of a product or service. A transaction management portal engine manages the commercial transaction performed by the user using user information. A management database provides the user information related to the commercial transaction.

### RELATED APPLICATIONS

This application is a continuation-in-part (CIP) of the following applications: (1) Ser. No. 09/931,677, titled “Discount Purchase Business Method”, filed Aug. 15, 2001, (2) Ser. No. 10/461,556, titled “Coupon Rebate Business Method Using Portable Personal Communication Devices”, filed Jun. 12, 2003.

### BACKGROUND

1. Field of the Invention

Embodiments of the invention relate to the field of commercial transactions, and more specifically to management of commercial transactions.

2. Description of the Related Art

Commercial transactions typically involve manufacturers, retailers, and consumer purchasers. In a typical commercial retail transaction, a consumer purchases a product or products of a manufacturer at a retailer. The product may be available at a discount. The discount may be provided by the manufacturer or the retailer. When there are a large number of transactions taking place, it is cumbersome for a retailer or a manufacturer to keep track of product discounts or promotional services to consumers.

Existing techniques to manage commercial retail transactions have a number of drawbacks. One technique involves the use of a system for the electronic management and redemption of coupons. The technique requires the use of a coupon card which contains a bar code scanner, a memory, a display screen, and a communication port. This technique requires complex circuitry embedded in the coupon card and may be too complex to use for an average consumer. Another technique processes rebate claims submitted by a consumer. The technique transfers the purchase data record from a point-of-sale (POS) to a fulfillment administrator. The fulfillment administrator credits the designated card used by the consumer. This technique does not provide the flexibility in communications among the consumer, the retailer, and the manufacturer.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system according to one embodiment of the invention.

FIG. 2 is a diagram illustrating a portal engine according to one embodiment of the invention.

FIG. 3 is a diagram illustrating a rule engine according to one embodiment of the invention.

FIG. 4 is a diagram illustrating a business rule according to one embodiment of the invention.

FIG. 5 is a diagram illustrating a database maintenance rule according to one embodiment of the invention.

FIG. 6 is a diagram illustrating a transaction rule according to one embodiment of the invention.

FIG. 7 is a diagram illustrating a participant rule according to one embodiment of the invention.

FIG. 8 is a diagram illustrating a verification rule according to one embodiment of the invention.

FIG. 9 is a diagram illustrating a graphical user interface according to one embodiment of the invention.

FIG. 10 is a diagram illustrating a transaction management portal engine or a controller according to one embodiment of the invention.

### DESCRIPTION

An embodiment of the invention a portal for commercial transactions. A user interface interfaces to a user performing a commercial transaction. The user is one of a consumer, a vendor, a retailer, a service provider, and a third-party entity. The commercial transaction is related to sale processing of a product or service. A transaction management portal engine manages the commercial transaction performed by the user using user information. A management database provides the user information related to the commercial transaction.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

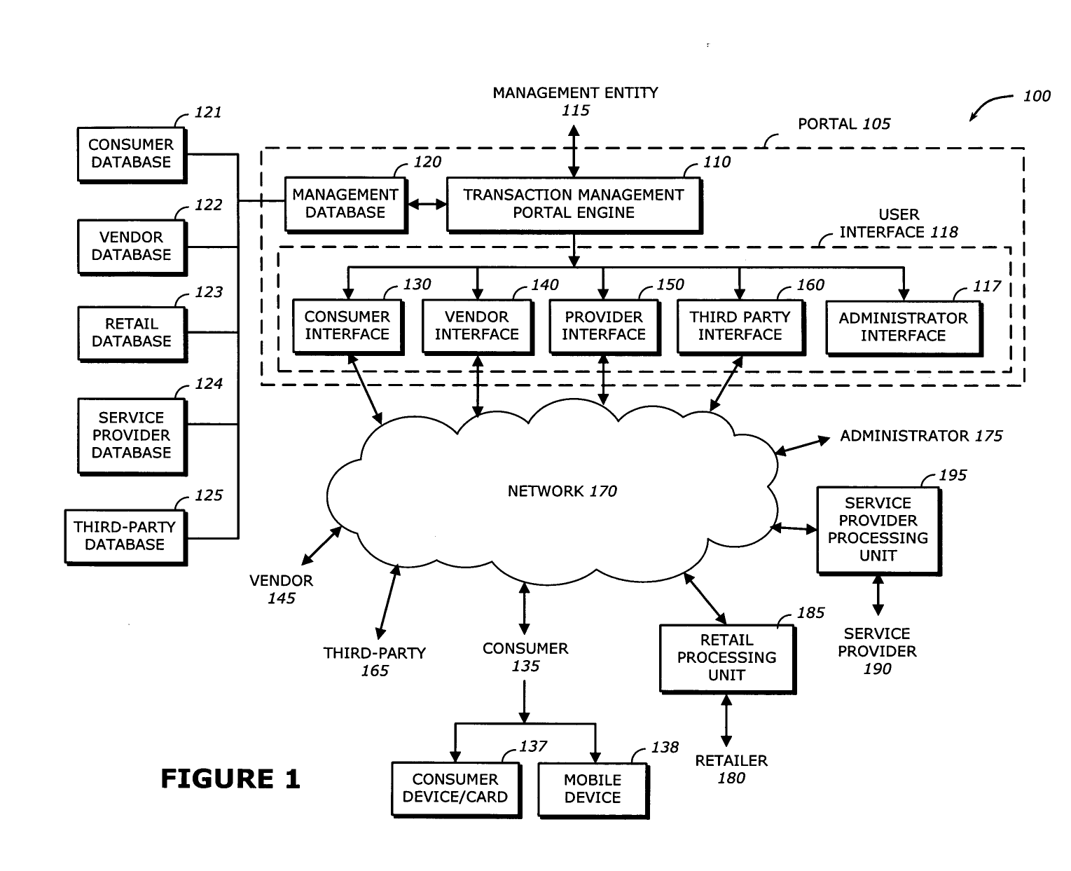

FIG. 1 is a diagram illustrating a system 100 according to one embodiment of the invention. The system 100 includes a portal 105, a network 170, a consumer 135, a vendor 145, a retailer 180, a service provider 190, a third-party entity 165, and an administrator 175. The system 100 may include more or less than the above components.

The portal 105 provides functionalities for a point of access on the Web. It provides a centralized management of commercial transactions that may involve various commercial entities or users such as consumers represented by the consumer 135, vendors and/or, manufacturers represented by the vendor 145, retailers represented by the retailer 180, service providers represented by the service provider 190, and third party entities (e.g., credit issuers, payment processing entities, advertisers) represented by the third-party entity 165. It includes a transaction management portal engine 110, a management database 120, and a user interface 118. The user interface 118 interfaces to a user performing a commercial transaction. The commercial transaction may be related to sale processing of a product or service. The user may be one of the consumer 135, the vendor 145, the retailer 180, the service provider 190, or the third-party entity 165. It includes a consumer interface 130, a vendor interface 140, a provider interface 150, and an administrator interface 117. The administrator interface 117 provides access to the portal 105 by the administrator 175. The administrator 175 is a person or an entity that is responsible for the administration of the portal 105. Most likely, the administrator 195 is an agent, an employee, a representative, or an official of the management entity 115.

The transaction management portal engine 110 is configured, set up, and operated by the management entity 115. It is part of the portal 105. It may manage the commercial transaction performed by the user using user information. The transaction management portal engine 110 may include a number of tools to configure, set up, and operate a portal. It may include a number of portlets customized for various users. It may include specialized processing subsystems or engines to process rules or obtain information related to the businesses involved in the sale processing of products or services administered by the portal 105

The management database 120 is a centralized database that integrates information provided by the commercial entities as part of the commercial management. The management database 120 may provide the user information related to the commercial transaction to the portal engine 110. It may include a consumer database 121, a vendor database 122, a retail database 123, a service provider database 124, and a third-party database 125.

In particular, the transaction management portal engine 110 provides interface to three main constituents of commercial entities: vendor, consumer, and provider. It may also have an interface to third-party entities. Each of the interfaces provides accessibility to the portal 105 by the commercial entities via the network 170.

The network 170 may be any suitable network such as the Internet or wireless network. Each of the participants may access the portal 105 via any suitable means including logging on to a computer with a Web browser, communicating via a wired or wireless network using a wireless device, such as a personal digital assistant (PDA), a cellular device, a portable computing device, a desktop personal computer (PC), a notebook PC, etc.

The commercial entities include the customer 135, the vendor 145, the third-party entity 165, the retailer 180, and the service provider 190. These entities are shown in singular form for brevity. It is understood that each entity may include a plurality of them. The consumer 135 is any consumer or an entity who purchases a product or receives a service. The consumer 135 communicates with the portal engine 110 via the consumer interface 130. The vendor 145 may be a seller, a manufacturer, a wholesaler, or any entity that creates, manufactures, or promotes a product. The vendor 145 communicates with the portal engine 110 via the vendor interface 140. The third-party entity 165 may be any entity that provides supplemental products or services to the transactions, such as sales representation, payment processing, advertisement, insurance brokerage, etc. The third-party entity 165 communicates with the portal engine 110 via the third-party interface 160. The retailer 180 may be any retailer to re-sell products provided by the vendor 145. For example, the retailer 180 may be a distributor, a wholesaler, a retail store, a supermarket, a grocery store, a shopping mall boutique, a department store, a restaurant, a movie theater, a hotel, etc. The service provider 190 may be any provider that provides a service to the consumer 135. For example, the service provider 190 may be a rental agency, a human resource agency, a professional (e.g., dentist, doctor, lawyer, accountant, real estate agent, engineer, financial advisor), etc. The retailer 180 and the service provider 190 communicate with the portal engine 110 via the appropriate components in the provider interface 150. The retailer 180 and the service provider 190 may be referred to as a provider.

The retailer 180 may have a retail processing unit 185 to process the transactions locally at the retailer's facility. The retail processing unit 185 may have connection to the network to communicate with the transaction management portal engine 110. Similarly, the service provider 190 may have a service provider processing unit 195 to process the transactions locally at the service provider's facility or office. The retail processing unit 185 or the service provider processing unit 195 may include a scanner or a reader to read or scan the consumer device 137. It may include a wireless receiver/transmitter to receive/transmit information from/to the mobile device 138.

The management entity 115 has an established relationship with at least one of the consumer 135, the vendor 145, the third-party entity 165, the retailer 180, and the service provider 190. The management entity 115 maintains all the relationships and provides the registered participants a centralized marketplace. Upon registration, each participant may receive a log-in name and/or password to allow the registered participant to access to the marketplace.

The consumer 135 may register with the management entity 115 to become a member in the consumer group managed by the management entity 115. Upon registration, the consumer 135 may provide personal information such as name, address, financial information (e.g., bank information, credit references). The information provided by the consumer 135 may be integrated into the management database 120. As a member, the consumer 135 may receive a number of benefits. The consumer 135 may receive a consumer device/card 137, a membership number, an authorization code, a discount code, or any unique identifier that identifies the consumer 135 as a registered participant with the management entity 115. The consumer device 137 may be a loyalty card, a saving card, a discount card, a membership card, a wallet card, or an identification card to allow the consumer 135 to provide verification information as a legitimate user of the discount or sales. The consumer device 137 may contain the information in barcode, magnetic strip, or in any form that can be read or scanned by a reader at the facility of the retailer 180 or the service provider 190. The consumer device 137 allows the consumer 135 to receive discounts or rebates on merchandises, products, or services offered by any other entities registered with the management entity 115. The consumer 135 may also access the consumer interface 130 to navigate through a variety of informational items such as announcements, advertisements, sales promotions, rebates or discounts, sweepstakes, lotteries, entitlements, cash-back offers, product catalogs, etc. The consumer 135 may perform an action on the informational items such as production selection, vendor and provider browsing and selection, discount or rebate redemption, on-line purchases, registration for receiving updates, newsletters, announcements, consumer card order, etc. The information provided by the consumer 135 may be integrated into the consumer database 121.

The consumer 135 may also have a mobile device 138 such as a cellular device (e.g., cell phone), a personal digital assistant (PDA), or any mobile device having a wireless receiver/transmitter. The wireless connection may be radio frequency (RF), optic, infrared, Bluetooth, or any other forms of wireless transmission. The membership number or authorization code may be stored in the mobile device 138. The mobile device 138 may be used by the consumer 135 to communicate the network 170, the retail processing unit 185, or the service provider processing unit 195 by transmitting the membership number or the authorization code. The mobile device 138 may have appropriate computing power including memory, input entry device (e.g., keyboard, trackball), display, etc. The mobile device 138 may also have appropriate operating system or programs to transmit a consumer card number, security information for verification, discount information, selected items, etc. to the network 170, the retail processing unit 185, or the service provider processing unit 195. The mobile device 138 may also have appropriate receiver circuitry to receive information downloaded from the portal 105. The downloaded information may include textual, graphical, or imaging information (e.g., rebate image) related to products or services supported by the portal 105.

The vendor 145 may register with the management entity 115 to become a member in the vendor group managed by the management entity 115. The vendor 145 may provide the management entity 115 a product catalog, price list, promotional information, etc to be stored in the vendor database 122. The vendor 145 may keep the information up-to-date by sending updates to the management entity 115. The information provided by the vendor 145 may be integrated into the vendor database 122. The information provided by the consumer 135 may be integrated into the consumer database 121.

The retailer 180 or the service provider 190 may register with the management entity 115 to become a member in the provider group managed by the management entity 115. The retailer 180 or the service provider 190 may provide the management entity 115 a product catalog, price list, promotional information, etc. The retailer 180 or the service provider 190 may keep the information up-to-date by sending updates to the management entity 115. The information provided by the retailer 180 or the service provider 190 may be integrated into the retail database 123 and service provider 124, respectively.

The third-party entity 165 may register with the management entity to become a member in the third-party group managed by the management entity 115. The third-party entity 165 may provide the management entity 115 a product catalog, price list, promotional information, etc. The third-party entity 165 may keep the information up-to-date by sending updates to the management entity 115. The information provided by the third-party entity 165 may be integrated into the third-party database 125.

The management entity 115 establishes a relationship with each of the consumer 135, the vendor 145, the retailer 180, the service provider 190, and the third-party entity 165 to provide a centralized management of commercial transactions. The consumer 135 is issued the consumer device 137 or a membership number to be entered in, and transmitted by, the mobile device 138 to receive discount on products or services purchased at the facility of the retailer 180 or the service provider 190. The management entity 115 may enter into contracts or agreements with the vendor 145, the retailer 180, the service provider 190, or the third-party entity 165 to publicize their products, services, or offers to a wide audience of consumers. In return, the management entity 115 may receive a fee or a payment. By providing a centralized database, the management entity 115 allows the consumer 135 to be able to browse through the product catalogs, promotional items, and other offers by the vendor 145, the retailer 180, the service provider 190, or the third-party entity 165 via the consumer interface 121. The vendor 145 or the third-party entity 165 may provide the management entity 115 the discount or rebate which can be passed onto the retailer 180 each time a transaction is made at the retailer 180. The retailer 180 may transmit the retail transactions to the management entity 115 via the provider interface 150 so that the management entity 115 may process the discount payment. The management entity 115 may also provide a discount or reward to the consumer 135.

The portal 105 acts as a centralized market place where the participants (e.g., the consumer 135, the vendor 145, the retailer 180) may perform many commercial transactions. The participants may create profiles, update their database, exchange information, post comments or messages, carry out real-time transactions, perform payments, etc.

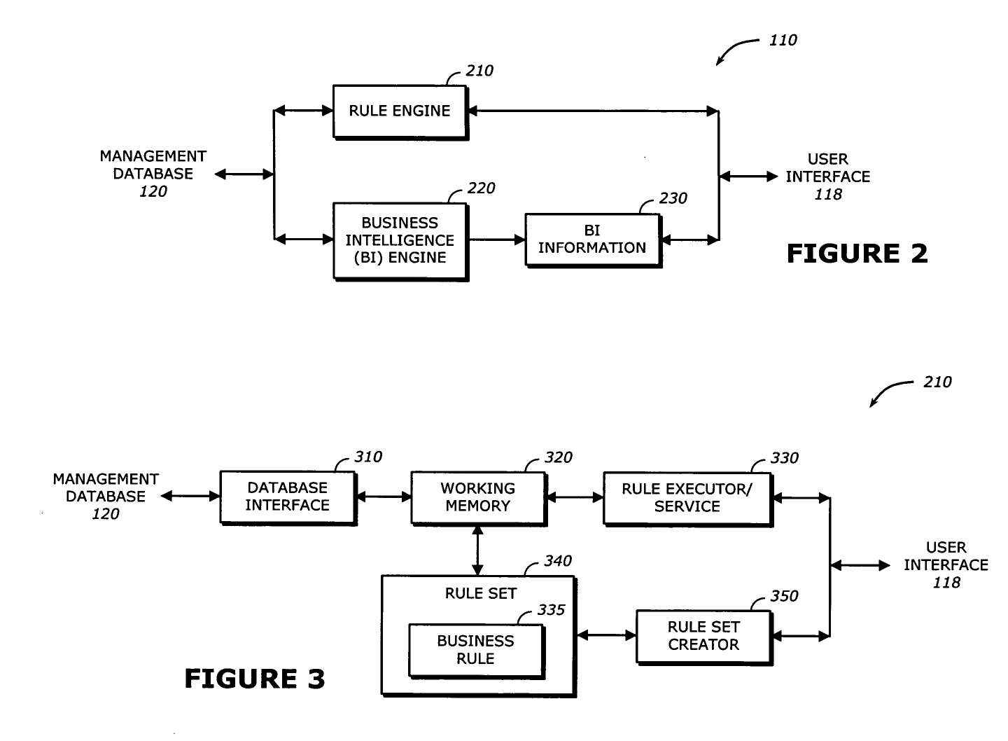

FIG. 2 is a diagram illustrating the portal engine 110 shown in FIG. 1 according to one embodiment of the invention. The portal engine 110 includes a rule engine 210 and a business intelligence (BI) engine 220. The portal engine 110 may include more or less than the above components.

The rule engine 210 is coupled to the management database 120 (FIG. 1) to process a business rule related to the sale processing of the product or service. The rule engine 210 is interfaced to the user interface 115. The rule engine 210 typically receives an input or inputs from a user via the respective user interface (e.g., the consumer interface 130) and responds with a response in a network session with the user. The user input may be a user action such as a click on a selection button on a Web page. The response may be a display of result on the Web page, a redirection to another Web page, and action performed within the management database 120. The rule engine 210 generates the result or response by executing the business rule related to the user input. The rule engine 210 may include functions or methods to execute the business rule according to triggering event. The triggering event may be an action on the user interface 118 or a real-time event (e.g., the consumer 135 presents consumer device 137 at the check-out stand at the retailer 180).

The BI engine 220 is coupled to the management database to generate BI data or information 230 using the information stored in the management database 120. The BI engine 220 may include BI tools such as profiler, trend analyzer, search tool, data aggregator, cluster analyzer, etc. The BI information 230 may include information relevant to the business conducted by any one of the portal participants such as the consumer 135, the vendor 145, the retailer 180 or the service provider 190.

FIG. 3 is a diagram illustrating the rule engine 210 shown in FIG. 2 according to one embodiment of the invention. The rule engine 210 includes a database interface 310, a working memory 320, a rule executor/service 330, a rule set 340, and a rule set creator 350. The rule engine 210 may include more or less than the above components.

The database interface 310 interfaces to the management database 120 to retrieve database information or to update/change the database information. For example, it may retrieve a user profile, a vendor catalog or product discounts, a retailer promotional campaign, etc. from the respective database. In another example, it may update the number of purchased items that receive discount in consumer information.

The working memory 320 is an area reserved for rule processing. It may be a buffer memory, a storage, or anything that have sufficient storage size to store database information and the rule or rules being processed.

The rule executor/service 330 selects a rule or a subset of rules to execute, and executes or fires the selected rule or rules. The rule executor/service 330 may execute a rule by a rule execution function. A rule is typically in the form “If condition, then action”. The rule execution function may match the rule condition with the contents or matching objects of the corresponding information stored in the working memory. Any conflict may then be resolved. If the rule condition is satisfied, the execution function performs the action specified in the action part of the rule. The action may produce new information or objects which may be stored back in the working memory. The execution function may repeatedly be applied to a rule until all rules are fired or executed.

An action performed by the rule executor/service 730 may generate new interface results which may be propagated to the user interface 118 to the corresponding interface page of a user. For example, when the rule “If consumer is verified and makes a purchase, then update the remaining eligible discount items the consumer's account.” The remaining eligible discount items may be currently displayed on a window of the consumer interface 130. The updating action may result in reducing the eligible discount items by the number of items being purchased with discount. This action may update a window containing the value of the number of remaining eligible discount items.

The rule set 340 contains a set of rules that is associated with the current session between the portal 105 and the participant. The rule set 340 may include a business rule 335 that is related to the sale processing of the product or service. The business rule 335 is one of the rules in the rule set 340. The business rule 335 is typically in the form “if condition, then action” where condition is a condition in the left hand side (LHS) to be met or satisfied. If the condition is met, the action in the right hand side (RHS) is performed. The condition may include a single condition or a number of conditions that are combined with logic connectives such as AND and OR. The condition and/or the action may be represented by an object.

The rule set creator 350 creates the business rule 335 in the rule set 340. The rule set creator 350 may be invoked by the administrator 175 (FIG. 1) via the administrator interface 117. The administrator 175 may access the rule set creator 350 as often as necessary to update, change, add, or edit the rules in the rule set 340. The rules may be represented by any suitable representation scheme such as eXtensible Markup Language (XML).

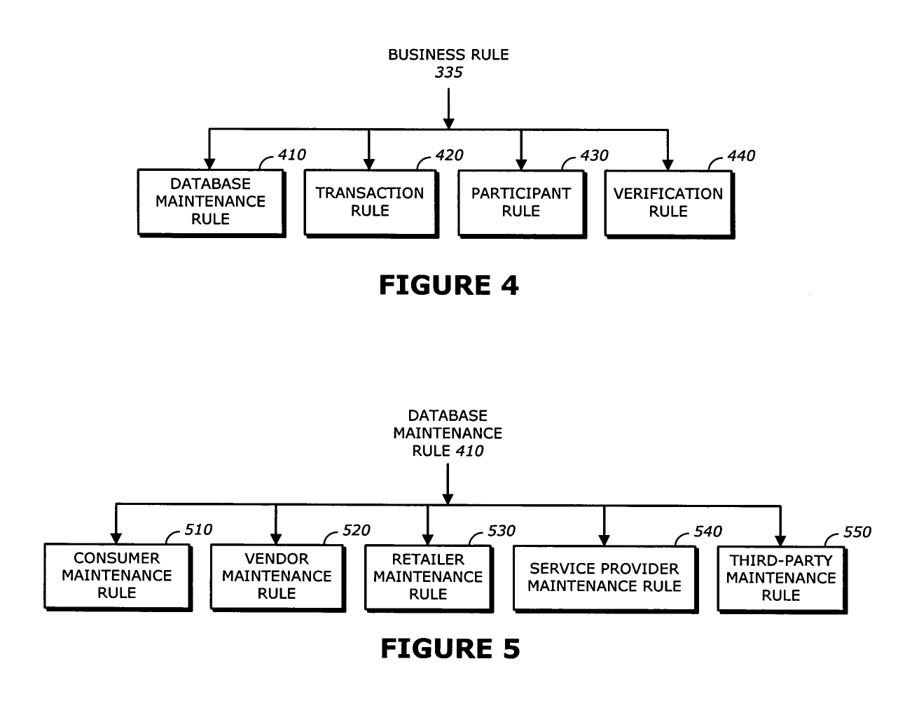

FIG. 4 is a diagram illustrating the business rule 335 shown in FIG. 3 according to one embodiment of the invention. The business rule 335 is a representative of one of the rules in the rule set 340. It is noted that there may be a very large number of rules in performing a variety of commercial transactions. The following is merely a representative set of business rules. The business rule 335 may be any one of a database maintenance rule 410, a transaction rule 420, a participant rule 430, and a verification rule 440. There may be more than the above types of rule for the business rule 335.

The database maintenance rule 410 updates the respective database information. The rule is invoked when the user wants to update the information, or when there is an action or transaction that affects the information. Typically, when a transaction is being carried out, such as when the consumer presents his or her consumer card to receive discount for a purchases item, the associated database maintenance rule 410 may be retrieved for processing. In another scenario, when a user (e.g., a vendor) logs on to his account to update his database information, the associated database maintenance rule 410 may be retrieved for processing.

The transaction rule 420 is invoked when there is a transaction related to a sale processing of a product or service, or when information regarding the transaction is being transmitted to the portal 105. It may be invoked by an action of a consumer or a retailer.

The participant rule 430 is related to transactions or operations that take place between a participant and another participant. It may be invoked by any participant who wishes the transaction or operation to be carried out.

The verification rule 440 is related to the verification or authentication of a participant, a transaction, a document, or any activity or any object. It may include rules to confirm or validate the identity of the consumer 135. It may be invoked when the consumer 135 presents the consumer device 137 at the check-out stand at the retailer 180.

FIG. 5 is a diagram illustrating the database maintenance rule 410 shown in FIG. 4 according to one embodiment of the invention. The database maintenance rule 410 may be one of a consumer maintenance rule 510, a vendor maintenance rule 520, a retailer maintenance rule 530, a service provider maintenance rule 540, or a third-party maintenance rule 550.

The consumer maintenance rule 510 updates the information of a consumer. The consumer information may include consumer personal information (e.g., log-in name, password, name, address, contact information, e-mail address), membership information (e.g., account number, date of registration), account information (e.g., credit/debit balance, discount received), profile (e.g., demographic group, product preferences, vendor preferences, retailer preferences, service provider preferences, third-party preferences), security information (e.g., encryption information, biometric data, security questions/answers). The preferences in the consumer's profile help preventing spam or unwanted advertisements to be sent to the consumer's account or mobile device.

The consumer maintenance rule 510 may also be one of a reward rule, a frequency rule, a demographic rule, a conversion rule, a current discount display rule, an opt-out receiving rule, and a notification rule. The reward rule provides rewarding the consumer for using the consumer card or using the services provided by the management entity 115. The frequency rule determines the frequency that the consumer 135 uses the services provided by the management entity 115 such as visiting a specific retailer, posting messages on the forum, etc. The demographic rule groups the consumers according to some demographic criteria such as age group, income level, etc. The conversion rule provides for the consumer 135 to convert discounts to reward points or vice versa. The current discount display rule allows the consumer 135 to use his or her consumer device 137 to see a display of current products that are being offered for sale with discount. The display may be on a kiosk or terminal that is connected to the portal 105. The opt-out receiving rule allows the consumer 135 to opt out receiving certain types of information to avoid receiving unwanted materials. The notification rule allows the consumer 135 to receive real-time notifications of discount information, product sales, promotional information, new products, etc, from selected participants.

The vendor maintenance rule 520 updates information of a vendor. The vendor information may include business personal information (e.g., log-in name, password, name, address, contact information), membership information (e.g., account number, date of registration), account information (e.g., credit/debit balance, discount provided, payments made, payments received), profile (e.g., product lines, geographic focus, consumer preferences, retailer preferences, service provider preferences, third-party preferences), security information (e.g., encryption information, biometric data, security questions/answers).

The retailer maintenance rule 530 updates information of a retailer. The retailer information may include business personal information (e.g., log-in name, password, name, address, contact information), membership information (e.g., account number, date of registration), account information (e.g., credit/debit balance, discount provided, payments made, payments received), profile (e.g., product lines, geographic focus, consumer preferences, vendor preferences, third-party preferences), security information (e.g., encryption information, biometric data, security questions/answers).

The service provider maintenance rule 540 updates information of a service provider. The service provider information may include business personal information (e.g., log-in name, password, name, address, contact information), membership information (e.g., account number, date of registration), account information (e.g., credit/debit balance, discount provided, payments made, payments received), profile (e.g., product lines, geographic focus, consumer preferences, vendor preferences third-party preferences), security information (e.g., encryption information, biometric data, security questions/answers).

The third-party maintenance rule 550 updates information of a third-party entity. The third-party information may include business personal information (e.g., log-in name, password, name, address, contact information), membership information (e.g., account number, date of registration), account information (e.g., credit/debit balance, discount provided, payments made, payments received), profile (e.g., product lines, geographic focus, consumer preferences, retailer preferences, service provider preferences, vendor preferences), security information (e.g., encryption information, biometric data, security questions/answers).

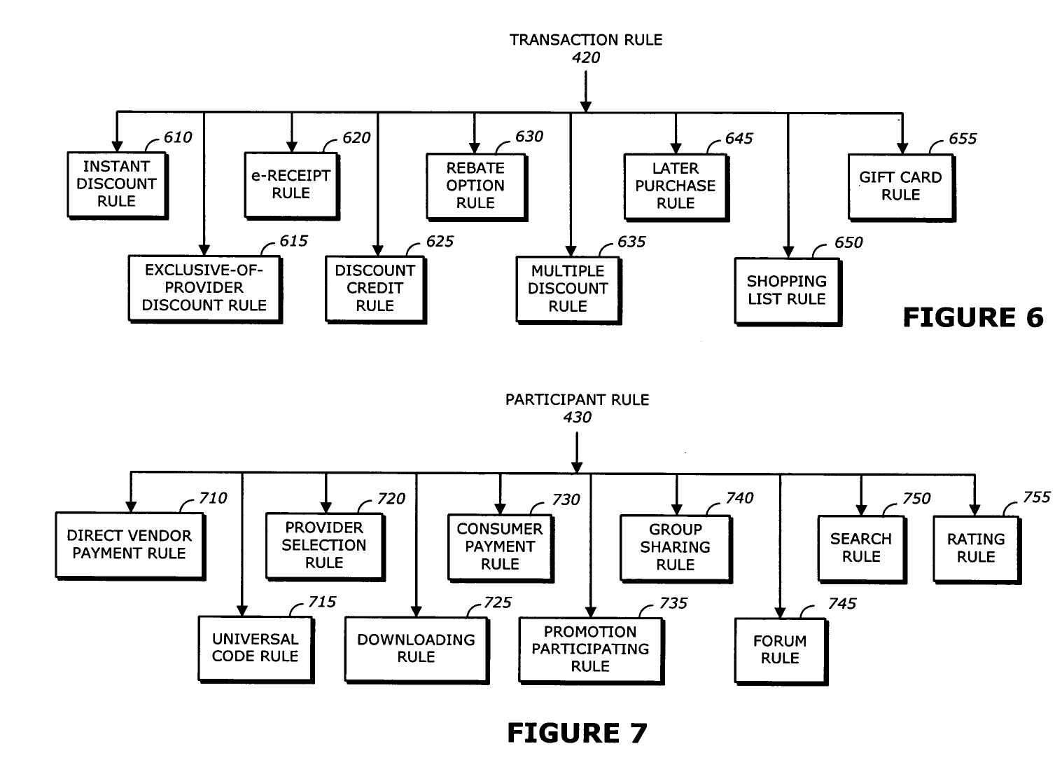

FIG. 6 is a diagram illustrating the transaction rule 420 shown in FIG. 4 according to one embodiment of the invention. The transaction rule 420 may be any one of an instant discount rule 610, an exclusive-of-provider discount rule 615, an electronic receipt (e-receipt) rule 620, a discount credit rule 625, a rebate option rule 630, a multiple discount rule 635, a later purchase rule 645, a shopping list rule 650, and a gift card rule 655.

The instant discount rule 610 provides for an instant discount given to the consumer 135 by the retailer 180 or the service provider 190 with or without requiring the consumer 137 to present the consumer device 137 when the consumer 135 purchases a product or receives a service.

The exclusive-of-provider discount rule 615 provides for a discount, exclusive of the retailer 180 or the service provider 190, given to the consumer 135 by the retailer 180 or the service provider 190 when the consumer purchases a product or receives a service.

In other words, the discount is offered by the vendor 145 or the management entity 115, not by the retailer 180 or the service provider 190.

The electronic receipt (e-receipt) rule 620 provides for an electronic receipt given to the consumer 135 instead of a paper receipt by the retailer 180 or the service provider 190 when the consumer 135 purchases a product or receives a service. The e-receipt may be sent directly to the account of the consumer 135, either to the personal e-mail address or to the e-mail account as registered at the portal 105.

The discount credit rule 625 provides for a discount given to the consumer 135 when the consumer 135 cannot get the discount due to server downtime, network malfunction or errors, or other technical difficulties. The discount is provided off-line or on-line (after the problem has been restored) if there is proof that the consumer 135 attempted to obtain the discount unsuccessfully due to the problem.

The rebate option rule 630 provides an option for the consumer 135 to select between an instant discount/rebate and a mail-in rebate. An instant discount may have a lower discount value than the mail-in rebate.

The multiple discount rule 635 provides for a merging of multiple discounts from various discounts such as discount from the retailer 180, discount from the service provider 190, discount from the third-party entity 165, discount from the vendor 145, or discount from the management entity 115.

The later purchase rule 645 provides for the consumer 135 to receive discount for a later purchase when the product is sold out or not available at the time the consumer 135 wants to purchase it.

The shopping list rule 650 provides for the consumer 135 to download or transfer selected items or products to the mobile device 138 before going to the retailer facility or store. The consumer 135 may then check the items at the store by displaying the downloaded items on the display screen of the mobile device 138.

The gift card rule 655 provides for the consumer 135 to purchase a gift card to give to another person. The gift card may be used in the same manner as the consumer device 137 to receive discounts or rebates.

FIG. 7 is a diagram illustrating the participant rule 430 according to one embodiment of the invention. The participant rule 430 may be one of a direct vendor payment rule 710, a universal code rule 715, a provider selection rule 720, a downloading rule 725, a consumer payment rule 730, a promotion participating rule 735, a group sharing rule 740, a forum rule 745, a search rule 750, a rating rule 755.

The direct vendor payment rule 710 provides for the vendor 145 to pay, reimburse, or compensate directly to the retailer 180, the service provider 190, or the third-party entity 165 directly without going through the management entity 115.

The universal code rule 715 provides for the merging of all the promotional codes, discount codes, rebate codes, coupon codes, etc. from one or more vendors, retailers, service providers, or third-party entities into a single number. This single number may be the membership number, the account number, or the identification number on the consumer device 137 of the consumer 135. By having only a single number, the consumer 135 does not have to remember or store different codes for different promotional campaigns offered by the participating vendors, retailers, service providers, or third-party entities. The default mode is that the consumer 135 automatically receives all the promotional deals or discounts offered by all the participating members (e.g., the vendor 145, the retailer 180, the service provider 190, and the third-party entity 165) unless a participating member specifically does not allow such a merging.

The provider selection rule 720 provides for a vendor to select a retailer or a service provider to carry the promotional campaign offered by the vendor. Typically, the selection is based on the retailer or service provider preferences as included in the vendor's profile. The preferences may include specific names of the retailer(s) or the service provider(s), the geographical areas, the types of providers (e.g., chain, boutiques, stores), the types of merchandise carried by the providers, etc.

The downloading rule 725 provides for the options to download discount information including coupon images, product images, product description, receipts, etc. to consumer's mobile device, PDA, computer, laptop, handheld device, automobile, etc. via wired or wireless connections, Internet, satellite such as through the global positioning system (GPS) satellites, etc.

The consumer payment rule 730 provides for the payment options by the consumer. The consumer may select a payment method such as payment by cash, payment by credit cards, payment by direct bank account, payment by credit points accumulated though discounts, etc. The payment may be for any types of purchases including physical items, products, services (e.g., bus fares, doctor's visits, car rental)

The promotion participating rule 735 provides for the consumer to participate in any promotional activities or saving methods such as gaming, sweepstakes, airline promotion, car rental promotion, phone cards, airline mileage, or any other reward cards using the consumer device 137 or the membership number.

The group sharing rule 740 provides for a participant to share his or her experience, interesting items, ratings, remarks, discount information, interesting promotional activities, etc. to other participants in the same group. For example, a consumer may send a link to another consumer about an active sales activity through the mobile device 138. A vendor may send an e-mail to another vendor to share ratings about retailers.

The forum rule 745 provides for a participant to post comments, news, or opportunities on a forum, a message board, a bulletin board, or any other public area The materials being posted may or may be checked for suitable contents. The posted materials may include buying or selling tips, opportunities, programs, campaigns, etc.

The search rule 750 provides for a participant to search for other participants or information on discounts, sales, rebates, products, shows, conventions, etc. The search criteria may include geographical location, product types, discount types, discount amount, participant rating, etc.

The rating rule 755 provides for a participant to rate another participant based on transactional experience. For example, a consumer may rate a retailer in terms of customer service, amount of discount, availability of products, etc.

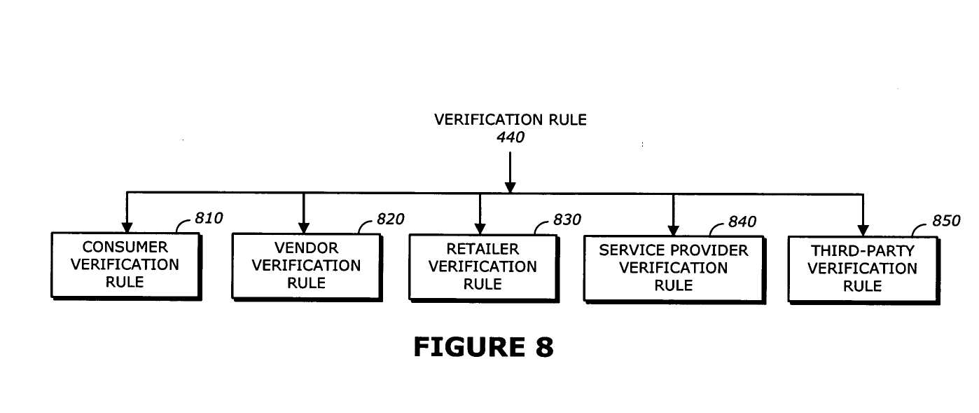

FIG. 8 is a diagram illustrating the verification rule 440 shown in FIG. 4 according to one embodiment of the invention. The verification rule 440 may be one of a consumer verification rule 810, a vendor verification rule 820, a retailer verification rule 830, a service provider verification rule 840, and a third-party entity verification rule 850.

The consumer verification rule 810 verifies or authenticates a consumer. The verification or authentication is to confirm that the consumer 135 is the legitimate holder of the consumer device 137. This may be performed by checking the consumer's various identifiers such as driver's license, passport, birth certificate, social security card, etc. Other security identification means may be used including biometric data (e.g., fingerprint, iris scan, DNA), security questions/answers, pictures, etc. The verification may also be used to verify that the user who is logging on an on-line session is the legitimate user. This may include requiring the user to enter responses to security questions, biometric data, or other security means. The security questions may be the tax identifier, password, secret question, etc. For on-line transactions, this may include the use of encryption techniques to ensure the information being transmitted is secure and tamper-proof.

The vendor verification rule 820 verifies or authenticates a vendor. The verification or authentication is to confirm that the user who is logging on an on-line session is the legitimate user. This may include requiring the user to enter responses to security questions, biometric data, or other security means. The security questions may be the tax identifier, password, secret question, etc. For on-line transactions, this may include the use of encryption techniques to ensure the information being transmitted is secure and tamper-proof.

The retailer verification rule 830 verifies or authenticates a retailer. The verification or authentication is to confirm that the user who is logging on an on-line session is the legitimate user. This may include requiring the user to enter responses to security questions, biometric data, or other security means. The security questions may be the tax identifier, password, secret question, etc. For on-line transactions, this may include the use of encryption techniques to ensure the information being transmitted is secure and tamper-proof.

The service provider verification rule 840 verifies or authenticates a service provider. The verification or authentication is to confirm that the user who is logging on an on-line session is the legitimate user. This may include requiring the user to enter responses to security questions, biometric data, or other security means. The security questions may be the tax identifier, password, secret question, etc. For on-line transactions, this may include the use of encryption techniques to ensure the information being transmitted is secure and tamper-proof.

The third-party entity verification rule 850 verifies or authenticates a third-party entity. The verification or authentication is to confirm that the user who is logging on an on-line session is the legitimate user. This may include requiring the user to enter responses to security questions, biometric data, or other security means. The security questions may be the tax identifier, password, secret question, etc. For on-line transactions, this may include the use of encryption techniques to ensure the information being transmitted is secure and tamper-proof.

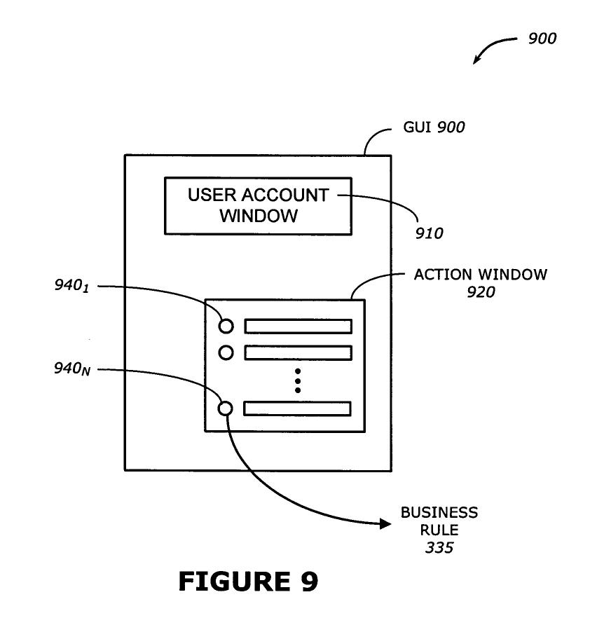

FIG. 9 is a diagram illustrating a graphical user interface (GUI) 900 according to one embodiment of the invention. The GUI 900 is a GUI that may be used in the user interface 118. The GUI 900 appears when the user logs on to access the portal 105 in a network connection. The GUI 900 includes several windows or pages that may be navigated by the user. The GUI 900 may be used to implement any one of the consumer interface 130, the vendor interface 140, the provider interface 150, the third party interface 160, and the administrator interface 117. For example, the GUI 900 may include a user account window 910 and an action window 920.

The user account window 910 displays the user account information. Depending on the type of user, the user account information may contain different types of information. For example, if the user is the consumer 135, the account information may include account name, account number, credit balance, point balance, etc.

The action window 920 is a window that may contain buttons or icons that cause an action when selected. It may include N action items 930₁ to 930_{N} with associated buttons 940₁ to 940_{N}. An action may invoke the execution of the business rule 335 that corresponds to the selected action item. The following are examples to illustrate some scenarios.

First scenario: The vendor 145 logs in to create or update the discounts. In this example, the action item 930₁ may be titled “Update discount”. When the vendor 145 clicks on the associate button 940₁ that corresponds to the action item 930₁, the GUI 900 transmits the action to the rule engine 210. The rule engine 210 may invoke a vendor maintenance rule 520. The rule engine 210 may then access the vendor database 122 via the database interface 310 to obtain a list of the products offered by the vendor 145. When this rule is executed, the vendor 145 may be directed to another page or window that displays the list of all the products offered by the vendor 145. When the vendor 145 clicks to select a product, another vendor maintenance rule 520 may be invoked to allow the vendor 145 to enter or edit the discount amount for the selected product.

Second scenario: The consumer 135 logs in to download a shopping list to his mobile device. In this example, the action item 930₁ may be titled “Download shopping list”. When the consumer 135 clicks on the associate button 940₁ that corresponds to the action item 930₁, the GUI 900 transmits the action to the rule engine 210. The rule engine 210 may invoke the shopping list rule 650. The rule engine 210 may then access the consumer database 121 to retrieve the consumer's profile. From this profile, the rule engine 210 may obtain all the products offered by a preferred retailer. When this rule is executed, the consumer 135 may be directed to another page or window that displays the list of all the products offered by the selected retailer. The consumer 135 may then browse through the products and select the products. After the consumer 135 selects the products, he or she may then click a button to start downloading. The rule engine 210 may then transmits the selected products to the mobile device 138 via a wired or wireless connection such as Bluetooth or USB.

Third scenario: The consumer 135 purchases an item at the retailer 180. The retailer 180 logs in to process the purchase. The consumer 135 presents his or her consumer device 137. The retailer 180 scans the consumer cards 137 through the retail processing unit 185. The consumer information is transmitted to the portal 105. The action item 930₁ may be titled “Discount”. When the retailer 180 clicks on the associated button 940₁ tha corresponds to the action item 9301, the GUI 900 transmits the action to the rule engine 210. The rule engine 210 may invoke the instant discount rule 610 and the multiple discount rule 635. The rule engine 210 then executes the rules and returns the discount amount to the retailer 180. Suppose further that the consumer 135 wants to receive an e-receipt instead of a paper receipt. The action item 930₂ may be titled “E-receipt”. When the retailer 180 clicks on the associated button 940₂ that corresponds to the action item 930₂, the GUI 900 transmits the action to the rule engine 210. The rule engine 210 may invoke the e-receipt rule 620. The rule engine 210 may then access the consumer database 121 to retrieve the consumer personal information and obtain the consumer's e-mail address. When the sale information is transmitted to the portal 105 by the retail processing unit 185, the rule engine 210 sends the sale information to the consumer's e-mail address.

The above scenarios are merely a few examples to illustrate the interactions between a user and the portal 105. There are an infinite number of possibilities for the transactions. The portal 105 provides a powerful and flexible mechanism to enable an efficient electronic commerce mechanism for commercial transactions among the participants.

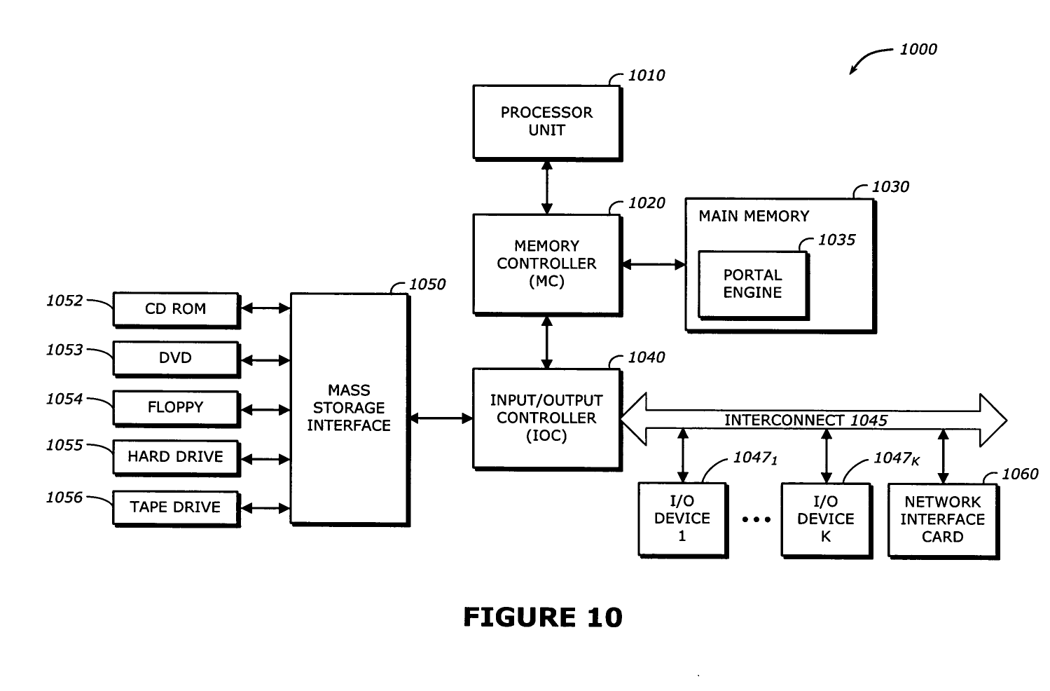

FIG. 10 is a diagram illustrating the transaction management portal engine 110 shown in FIG. 1 according to one embodiment of the invention. The controller 230 includes a processor unit 1010, a memory controller (MC) 1020, a main memory 1030, a graphics processor 1040, an input/output controller (IOC) 1050, an interconnect 1055, a mass storage interface 1070, and input/output (I/O) devices 1080₁ to 1080_{K}.

The processor unit 1010 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 1020 provides control and configuration of memory and input/output devices such as the main memory 1030 and the IOC 1040. The MC 1020 may be integrated into a chipset that integrates multiple functionalities such as graphics, media, isolated execution mode, host-to-peripheral bus interface, memory control, power management, etc. The MC 1020 or the memory controller functionality in the MCH 1020 may be integrated in the processor unit 1010. In some embodiments, the memory controller, either internal or external to the processor unit 1010, may work for all cores or processors in the processor unit 1010. In other embodiments, it may include different portions that may work separately for different cores or processors in the processor unit 1010.

The main memory 1030 stores system code and data. The main memory 1030 is typically implemented with dynamic random access memory (DRAM), static random access memory (SRAM), or any other types of memories including those that do not need to be refreshed. The main memory 1030 may include multiple channels of memory devices such as DRAMs. The main memory 1030 may include a portal engine 1035. The portal engine 1035 includes program instructions and data to perform portal functions. These functions may include the functions performed by the portal engine 110 (FIG. 1).

The graphics processor 1040 is any processor that provides graphics functionalities. The graphics processor 1040 may also be integrated into the MC 1020 to form a Graphics and Memory Controller (GMC). The graphics processor 1040 may be a graphics card such as the Graphics Performance Accelerator (AGP) card, interfaced to the MC 1020 via a graphics port such as the Accelerated Graphics Port (AGP) or a peripheral component interconnect (PCI) Express interconnect. The graphics processor 1040 provides interface to an external display device such as standard progressive scan monitor, television (TV)-out device, and Transition Minimized Differential Signaling (TMDS) controller.

The IOC 1050 has a number of functionalities that are designed to support I/O functions. The IOC 1050 may also be integrated into a chipset together or separate from the MC 1020 to perform I/O functions. The IOC 1050 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 1055 provides interface to peripheral devices. The interconnect 855 may be point-to-point or connected to multiple devices. For clarity, not all interconnects are shown. It is contemplated that the interconnect 1055 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 1070 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 1072, digital versatile disc (DVD) 1073, floppy drive 1074, hard drive 1075, tape drive 1076, and any other magnetic or optic storage devices. The mass storage device provides a mechanism to read machine-accessible media.

The I/O devices 1080₁ to 1080_{K} may include any I/O devices to perform I/O functions. Examples of I/O devices 1080₁ to 1080_{K} include controller for input devices (e.g., keyboard, mouse, trackball, pointing device, and remote control unit), media card (e.g., audio, video, and graphic), network card, and any other peripheral controllers.

Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include information or data that, when accessed by a machine, cause the machine to perform the operations or actions described above. The machine accessible medium may also include program code embedded therein. The program code may include machine readable code to perform the operations described above. The term “information” or “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A portal comprising:
a user interface to interface to a user performing a commercial transaction, the user being one of a consumer, a vendor, a retailer, a service provider, and a third-party entity, the commercial transaction being related to sale processing of a product or service;
a transaction management portal engine coupled to the user interface to manage the commercial transaction performed by the user using user information; and
a management database coupled to the portal engine to provide the user information related to the commercial transaction.

2. The portal of claim 1 wherein the user interface comprises at least one of a consumer interface, a vendor interface, a provider interface, and a third-party interface.

3. The portal of claim 1 wherein the management database comprises at least one of a consumer database, a vendor database, a retail database, a service provider database, and a third-party database.

4. The portal of claim 3 wherein the portal engine comprises:
a rule engine coupled to the management database to process a business rule related to the sale processing of the product or service.

5. The portal of claim 4 wherein the business rule is one of a database maintenance rule, a transaction rule, a participant rule, and a verification rule.

6. The portal of claim 5 wherein the database maintenance rule is one of a consumer maintenance rule, a vendor maintenance rule, a retailer maintenance rule, a service provider maintenance rule, and a third-party maintenance rule.

7. The portal of claim 5 wherein the transaction rule is one of an instant discount rule, an exclusive-of-provider discount rule, an electronic receipt (e-receipt) rule, a discount credit rule, a rebate rule, a multiple discount rule, an instant and mail-in rebate rule, a later purchase rule, a shopping list rule, and a gift card rule.

8. The portal of claim 6 wherein the participant rule is one of a direct vendor payment rule, a universal code rule, provider selection rule, a downloading rule, a consumer payment rule, a promotion participating rule, a group sharing rule, a forum rule, a search rule.

9. The portal of claim 6 wherein the verification rule is one of a consumer verification rule, a vendor verification rule, a retailer verification rule, a service provider verification rule, and a third-party entity verification rule.

10. The portal of claim 6 wherein the consumer maintenance rule is one of a reward rule, a frequency rule, a demographic rule, a conversion rule, a current discount display rule, an opt-out receiving rule, and a notification rule.

11. The portal of claim 3 wherein the portal engine further comprises:
a business intelligence (BI) engine coupled to the management database to generate BI data.

12. A method comprising:
interfacing to a user performing a commercial transaction using a user interface, the user being one of a consumer, a vendor, a retailer, a service provider, and a third-party entity, the commercial transaction being related to sale processing of a product or service;
managing the commercial transaction performed by the user using user information; and
providing the user information related to the commercial transaction using a management database.

13. The method of claim 12 wherein managing comprises:
processing a business rule related to the sale processing of the product or service.

14. The method of claim 13 wherein managing further comprises:
generating business intelligence (BI) data.

15. The method of claim 13 wherein processing the business rule comprises:
invoking the business rule when a user performs an action on the user interface.

16. The method of claim 12 wherein the user interface comprises at least one of a consumer interface, a vendor interface, a provider interface, and a third-party interface.

17. The method of claim 12 wherein the management database comprises at least one of a consumer database, a vendor database, a retail database, a service provider database, and a third-party database.

18. The method of claim 13 wherein the business rule is one of a database maintenance rule, a transaction rule, a participant rule, and a verification rule.

19. The method of claim 18 wherein the database maintenance rule is one of a consumer maintenance rule, a vendor maintenance rule, a retailer maintenance rule, a service provider maintenance rule, and a third-party maintenance rule.

20. The method of claim 18 wherein the transaction rule is one of an instant discount rule, an exclusive-of-provider discount rule, an electronic receipt (e-receipt) rule, a discount credit rule, a rebate rule, a multiple discount rule, an instant and mail-in rebate rule, a later purchase rule, a shopping list rule, and a gift card rule.

21. The method of claim 18 wherein the participant rule is one of a direct vendor payment rule, a universal code rule, provider selection rule, a downloading rule, a consumer payment rule, a promotion participating rule, a group sharing rule, a forum rule, a search rule.

22. The method of claim 18 wherein the verification rule is one of a consumer verification rule, a vendor verification rule, a retailer verification rule, a service provider verification rule, and a third-party entity verification rule.

23. The method of claim 18 wherein the consumer maintenance rule is one of a reward rule, a frequency rule, a demographic rule, a conversion rule, a current discount display rule, an opt-out receiving rule, and a notification rule.

24. An article of manufacture comprising:
a machine-accessible storage medium including information that, when accessed by a machine, cause the machine to perform operations comprising:
interfacing to a user performing a commercial transaction using a user interface, the user being one of a consumer, a vendor, a retailer, a service provider, and a third-party entity, the commercial transaction being related to sale processing of a product or service;
managing the commercial transaction performed by the user using user information; and
providing the user information related to the commercial transaction using a management database.

25. The article of manufacture of claim 24 wherein the information causing the machine to perform managing comprises information that, when accessed by a machine, cause the machine to perform operations comprising:
processing a business rule related to the sale processing of the product or service.

26. The article of manufacture of claim 25 wherein the information causing the machine to perform managing further comprises information that, when accessed by a machine, cause the machine to perform operations comprising:
generating business intelligence (BI) data.

27. The article of manufacture of claim 13 wherein the information causing the machine to perform processing the business rule comprises information that, when accessed by a machine, cause the machine to perform operations comprising:
invoking the business rule when a user performs an action on the user interface.
